(19) United States
(12) Patent Application Publication
(10) Pub. No.: US 2023/0391307 A1
(43) Pub. Date: Dec. 7, 2023

(54) VEHICLE BRAKE DEVICE

(71) Applicant: ADVICS CO., LTD., Kariya-shi, Aichi-ken (JP)

(72) Inventors: Tsuyoshi OTAKE, Kariya-shi, Aichi-ken (JP); Atsushi TAKAHASHI, Kariya-shi, Aichi-ken (JP)

(73) Assignee: ADVICS CO., LTD., Kariya-shi, Aichi-ken (JP)

(21) Appl. No.: 18/249,386

(22) PCT Filed: Oct. 26, 2021
(86) PCT No.: PCT/JP2021/039533

§ 371 Date: Apr. 18, 2023

(30) Foreign Application Priority Data
Oct. 30, 2020 (JP) 2020-183194

(51) Int. Cl. B60T 13/74; B60T 13/14; F15B 21/00

(52) U.S. Cl. CPC B60T 13/745; F15B 2211/665; F15B 21/00; B60T 13/148

(57) ABSTRACT

A vehicle brake device includes a first electric motor and a second electric motor; a first electrically powered cylinder device and a second electrically powered cylinder device driven by the first electric motor and the second electric motor, respectively; and a circuit board on which a first circuit and a second circuit for controlling the first electric motor and the second electric motor, respectively, are formed. In the vehicle brake device, the first electrically powered cylinder device and the second electrically powered cylinder device are arranged side by side in the radial direction with the axis thereof being parallel to each other, and the circuit board is arranged perpendicular to the axis of the first electrically powered cylinder device and the second electrically powered cylinder device.

### TECHNICAL FIELD

The present disclosure relates to a vehicle brake device.

### BACKGROUND ART

A vehicle brake device pump disclosed in Patent Literature 1, for example, is conventionally known. The conventional vehicle brake device includes an electric motor, an electrically powered cylinder device driven by the electric motor, a hydraulic block to which the electric motor and the electrically powered cylinder device are assembled, and a control device that controls the electric motor. In the conventional vehicle brake device, the control device is disposed with respect to the hydraulic block so as to be parallel to the axial direction of the cylinder configuring the electrically powered cylinder device.

### CITATIONS LIST

### Patent Literature

Patent Literature 1: JP 2017-216094 A

### SUMMARY

### Technical Problems

In general, in a vehicle brake device, various electromagnetic valves for adjusting a braking fluid pressure generated by an electrically powered cylinder device with respect to a hydraulic block are provided, and the various electromagnetic valves are electrically connected to a circuit board configuring a control device. In this case, the various electromagnetic valves are arranged in the hydraulic block so as not to interfere with, for example, the rotating shaft of the electric motor or the electrically powered cylinder device, and are electrically connected to the circuit board of the control device.

In the conventional vehicle brake device, the electrically powered cylinder device becomes long along the axis. Thus, the projection area when the electrically powered cylinder device is projected with respect to the control device increases in the direction perpendicular to the axis of the electrically powered cylinder device. Therefore, when arranging the various electromagnetic valves, the electromagnetic valves need to be arranged so as not to interfere with the electrically powered cylinder device, that is, so as to avoid a portion where the electrically powered cylinder device is projected with respect to the control device. For this reason, the circuit board, that is, the control device increases in size, and as a result, the vehicle brake device may increase in size. In addition, in a case where the various electromagnetic valves are arranged between the rotating shaft of the electric motor or the cylinder and the control device in the direction perpendicular to the axis of the electrically powered cylinder device, the hydraulic block needs to be thickened although the circuit board of the control device can be reduced in size. As a result, in this case as well, the vehicle brake device may increase in size.

The present disclosure has been made to solve the above problems, and an object thereof is to provide a vehicle brake device that can be reduced in size.

### Solutions to Problems

A vehicle brake device according to the present disclosure includes an electric motor, a plurality of electrically powered cylinder devices driven by the electric motor and causes the fluid pressure chamber defined by the cylinder and the piston to generate a fluid pressure corresponding to a position of a piston sliding in the cylinder, and a circuit board on which an electric circuit that controls the electric motor is formed, where the plurality of electrically powered cylinder devices are arranged side by side in a radial direction with axes thereof being parallel to each other, and the circuit board is disposed perpendicular to the axis of the electrically powered cylinder device.

### Advantageous Effects

According to the vehicle brake device of the present disclosure, the circuit board is disposed perpendicular to the axis of the electrically powered cylinder device. As a result, in the direction of the axis of the electrically powered cylinder device, the projection area when the electrically powered cylinder device is projected with respect to the circuit board is smaller than the projection area of the electrically powered cylinder device in the conventional vehicle brake device described above. As a result, the degree of freedom in arrangement of components (e.g., various electromagnetic valves etc.) provided in the vehicle brake device is improved. As a result, the vehicle brake device can be reduced in size.

### BRIEF DESCRIPTION OF DRAWINGS

FIG. 1 is a perspective view illustrating a configuration of a vehicle brake device according to an embodiment of the present disclosure.

FIG. 2 is a cross-sectional view for explaining in detail the configuration of the vehicle brake device.

FIG. 3 illustrates a configuration of a hydraulic block forming the vehicle brake device and is a perspective view when the vehicle brake device is viewed from a side on which an electric motor is assembled.

FIG. 4 illustrates a configuration of a hydraulic block forming the vehicle brake device and is a perspective view when the vehicle brake device is viewed from a side on which a control unit is assembled.

FIG. 5 is a perspective view for explaining a configuration of the control unit.

FIG. 6 is a diagram for explaining a configuration of a circuit board forming the control unit.

### DESCRIPTION OF EMBODIMENT

Hereinafter, an embodiment of the present disclosure will be described with reference to the drawings. Note that the drawings used in the following description of the embodiment are conceptual diagrams, and the shape of each part may not necessarily be exact in some cases.

### 1. Configuration of Vehicle Brake Device 10

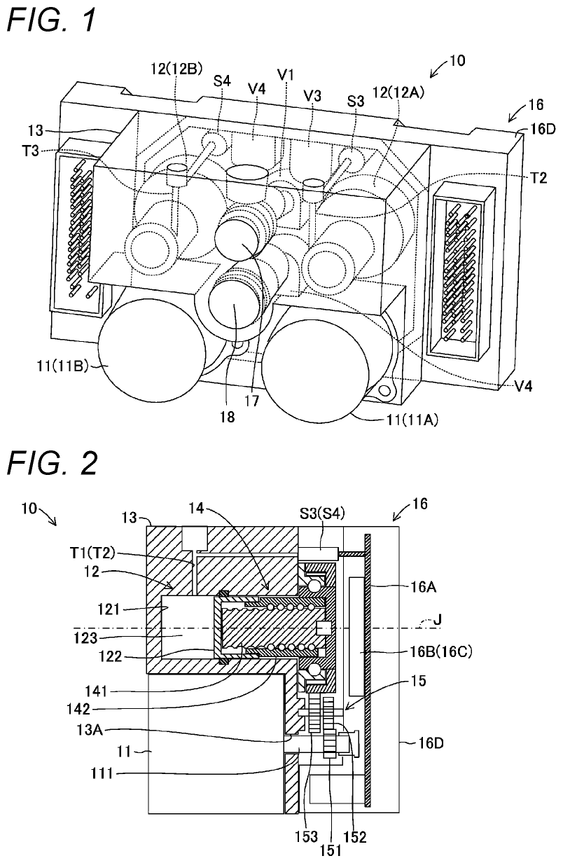

A configuration of the vehicle brake device 10 of the present embodiment will be described in detail. As illustrated in FIG. 1, the vehicle brake device 10 includes two electric motors 11, two electrically powered cylinder devices 12, a hydraulic block 13, a control unit 16, a master cylinder 17, and a stroke simulator 18. As illustrated in FIG. 2, the vehicle brake device 10 of the present embodiment includes a linear motion conversion mechanism 14 and a power transmission unit 15. Note that in the following description, when the two electric motors 11 and the two electrically powered cylinder devices 12 are distinguished as a “first element” and a “second element”, respectively, the electric motor 11 is referred to as a “first electric motor 11A” of the first element and a “second electric motor 11B” of the second element, and the electrically powered cylinder device 12 is referred to as a “first electrically powered cylinder device 12A” of the first element and a “second electrically powered cylinder device 12B” of the second element.

Here, as illustrated in FIG. 1, the vehicle brake device 10 of the present embodiment includes a first electric motor 11A and a second electric motor 11B, and a first electrically powered cylinder device 12A and a second electrically powered cylinder device 12B driven by the first electric motor 11A and the second electric motor 11B, respectively. That is, the vehicle brake device 10 includes the first electrically powered cylinder device 12A driven by the first electric motor 11A and the second electrically powered cylinder device 12B driven by the second electric motor 11B. As described above, in the vehicle brake device 10, each of the first electric motor 11A and the first electrically powered cylinder device 12A, and the second electric motor 11B and the second electrically powered cylinder device 12B are provided as a pair, and each pair has redundancy that can independently generate the braking fluid pressure.

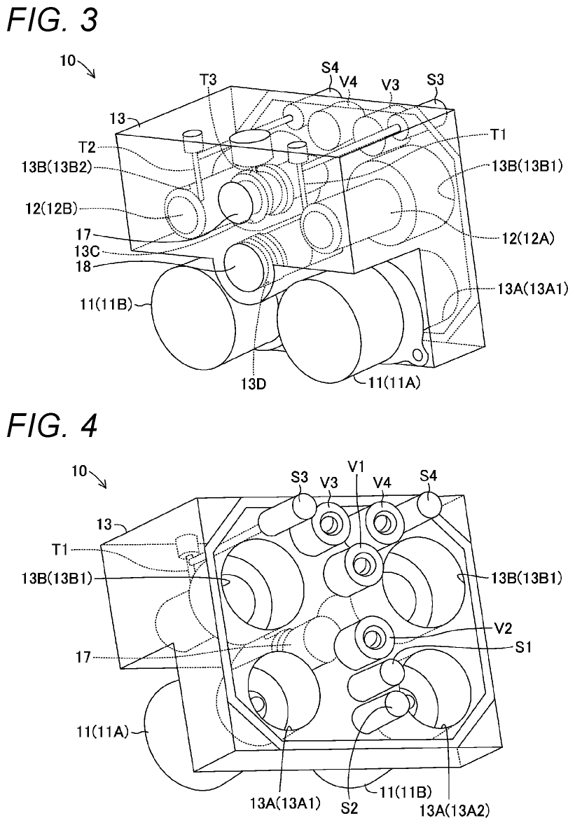

As illustrated in FIG. 2, the two electric motors 11 (the first electric motor 11A and the second electric motor 11B) and the two electrically powered cylinder devices 12 (the first electrically powered cylinder device 12A and the second electrically powered cylinder device 12B) are attached to the hydraulic block 13 such that axes of the rotating shaft 111 of the electric motor 11 and the cylinder 121 (the electrically powered cylinder device 12) are parallel to each other. Here, as illustrated in FIG. 3, in the vehicle brake device 10, in a posture mounted on the vehicle, the electric motor 11 is disposed on the rear side in the vehicle front-rear direction, specifically, on a surface side facing a partition wall (also referred to as a dashboard, a dash panel, or a dash cowl) of the vehicle in the hydraulic block 13. Furthermore, the electrically powered cylinder device 12 is accommodated inside the hydraulic block 13 so as to be on the rear side in the vehicle front-rear direction.

The electric motor 11 generates a rotational driving force to drive the electrically powered cylinder device 12, and has a rotating shaft 111, as illustrated in FIG. 2. As illustrated in FIG. 4, the rotating shaft 111 enters into a rotating shaft accommodating portion 13A formed in the hydraulic block 13 to be described later, and supplies rotational motion (rotational driving force) to the electrically powered cylinder device 12 (see FIG. 3).

As illustrated in FIG. 2, the electrically powered cylinder device 12 mainly includes a cylinder 121, a piston 122, and a fluid pressure chamber 123. The cylinder 121 is assembled inside the hydraulic block 13. Each cylinder 121 is connected to a reservoir (not illustrated) by way of a liquid path T1 and a liquid path T2, and slidably accommodates the piston 122 therein. Here, the cylinders 121 (the electrically powered cylinder device 12) are arranged side by side in the radial direction with axes J thereof being parallel to each other (see, e.g., FIG. 1). The piston 122 is coaxially coupled to the linear motion conversion mechanism 14, and moves in the axial direction of the cylinder 121 together with a ball screw 141, described later, which is a linear moving portion. The fluid pressure chamber 123 is formed by the inner peripheral surface of the cylinder 121 and the piston 122.

As a result, in the fluid pressure chamber 123, the brake fluid is pressurized with the movement of the piston 122 in the compressing direction (left direction in FIG. 2), and the braking fluid pressure corresponding to the position of the piston 122 is generated. The braking fluid pressure generated in the fluid pressure chamber 123 is supplied to wheel cylinders provided in the first wheel (e.g., the left front wheel of the vehicle) and the second wheel (e.g., the right front wheel of the vehicle) via a liquid path (not illustrated) formed in the hydraulic block 13.

As illustrated in FIGS. 3 and 4, in the hydraulic block 13, two rotating shaft accommodating portions 13A corresponding to the two electric motors 11 (the first electric motor 11A and the second electric motor 11B) on a one-to-one basis are formed. The rotating shaft 111 of the corresponding electric motor 11 is inserted into and accommodated in the rotating shaft accommodating portion 13A. Here, the rotating shaft accommodating portion 13A is formed such that the rotating shaft 111 is parallel to the axis J of the electrically powered cylinder device 12, and the first electric motor 11A and the second electric motor 11B are arranged side by side in the radial direction. When the rotating shaft accommodating portion 13A is distinguished in the following description, the rotating shaft accommodating portion 13A accommodating the rotating shaft 111 of the first electric motor 11A is referred to as a “first rotating shaft accommodating portion 13A1”, and the rotating shaft accommodating portion 13A accommodating the rotating shaft 111 of the second electric motor 11B is referred to as a “second rotating shaft accommodating portion 13A2”.

In the hydraulic block 13, two cylinder accommodating portions 13B corresponding to the two electrically powered cylinder devices 12 (more specifically, the cylinder 121 of the first electrically powered cylinder device 12A and the cylinder 121 of the second electrically powered cylinder device 12B) on a one-to-one basis are formed. The cylinder accommodating portion 13B accommodates the corresponding electrically powered cylinder device 12. When the cylinder accommodating portion 13B is distinguished in the following description, the cylinder accommodating portion 13B accommodating the cylinder 121 of the first electrically powered cylinder device 12A is referred to as a “first cylinder accommodating portion 13B1”, and the cylinder accommodating portion 13B accommodating the cylinder 121 of the second electrically powered cylinder device 12B is referred to as a “second cylinder accommodating portion 13B2”.

Here, the rotating shaft accommodating portion 13A and the cylinder accommodating portion 13B are formed so as to be parallel to each other and not to be coaxial with each other. The first rotating shaft accommodating portion 13A1 and the second rotating shaft accommodating portion 13A2 are disposed apart from each other in the hydraulic block 13. Similarly, the first cylinder accommodating portion 13B1 and the second cylinder accommodating portion 13B2 are disposed apart from each other in the hydraulic block 13. That is, in the hydraulic block 13, as illustrated in FIGS. 3 and 4, a central portion for arranging the master cylinder 17 and the stroke simulator 18 is formed.

As a result, as illustrated in FIG. 3, a master cylinder accommodating portion 13C for accommodating the master cylinder 17 and a stroke simulator accommodating portion 13D for accommodating the stroke simulator 18 are formed at the central portion of the hydraulic block 13. As illustrated in FIG. 4, a master cut valve V1 and a simulator cut valve V2 are assembled to the central portion of the hydraulic block 13. In addition, a master pressure sensor S1 and a master pressure sensor S2 are assembled, and a stroke sensor (not illustrated) is assembled to the central portion of the hydraulic block 13. Note that in the present embodiment, the master pressure sensors S1 and S2 are provided to have redundancy. However, if necessary, one master pressure sensor and one stroke sensor can be provided to have redundancy.

That is, the master cylinder 17, the stroke simulator 18, the master cut valve V1, the simulator cut valve V2, the master pressure sensor S1, and the stroke sensor S2 assembled to the central portion of the hydraulic block 13 are arranged at a boundary (alternatively, a region between the first region R1 and the second region R2) between a first region R1 including a first sector K1 and a second region R2 including a second sector K2 in the control unit 16 to be described later.

Furthermore, as illustrated in FIG. 4, in the hydraulic block 13, a first electromagnetic valve V3 and a first pressure sensor S3 serving as first elements are assembled in the first region R1, described later, which is located on the peripheral edge portion side than the central portion and in which the first electric motor 11A and the first electrically powered cylinder device 12A are disposed. In addition, in the hydraulic block 13, a second electromagnetic valve V4 and a second pressure sensor S4 serving as second elements are assembled in the second region R2, described later, which is located on the peripheral edge portion side than the central portion and in which the second electric motor 11B and the second electrically powered cylinder device 12B are disposed. That is, the first rotating shaft accommodating portion 13A1 of the hydraulic block 13 in which the rotating shaft 111 of the first electric motor 11A is accommodated, the first cylinder accommodating portion 13B1 in which the cylinder 121 of the first electrically powered cylinder device 12A is accommodated, the first electromagnetic valve V3, and the first pressure sensor S3 are disposed in the first region R1. The second rotating shaft accommodating portion 13A2 of the hydraulic block 13 in which the rotating shaft 111 of the second electric motor 11B is accommodated, the second cylinder accommodating portion 13B2 in which the cylinder 121 of the second electrically powered cylinder device 12B is accommodated, the second electromagnetic valve V4, and the second pressure sensor S4 are disposed in the second region R2.

As will be described later, the master cut valve V1 switches communication or cut-off between the master cylinder 17 accommodated in the hydraulic block 13 and the first wheel (e.g., the left front wheel of the vehicle) and the second wheel (e.g., the right front wheel of the vehicle) of the vehicle according to the energization state from the control unit 16. The simulator cut valve V2 cuts off the master cylinder 17 and the stroke simulator 18 in a case where the master cut valve V1 is in the communicating state and communicates the master cylinder 17 and the stroke simulator 18 in a case where the master cut valve V1 is in the cutoff state according to the energization state from the control unit 16. Here, the master cut valve V1 and the simulator cut valve V2 are controlled by both the first ECU 16B and the second ECU 16C configuring the control unit 16 as will be described later. Therefore, the master cut valve V1 and the simulator cut valve V2 correspond to a “third element”.

The first electromagnetic valve V3 is disposed in a liquid path connecting the first electrically powered cylinder device 12A and a wheel cylinder provided on the first wheel (e.g., the left front wheel of the vehicle), and switches communication or cut-off between the first electrically powered cylinder device 12A and the wheel cylinder according to the energization state from the control unit 16. The second electromagnetic valve V4 is disposed in a liquid path connecting the second electrically powered cylinder device 12B and a wheel cylinder provided on the second wheel (e.g., the right front wheel of the vehicle), and switches communication or cut-off between the second electrically powered cylinder device 12B and the wheel cylinder according to an energization state from the control unit 16.

The master pressure sensors S1 and S2 detect the braking fluid pressure (master pressure) generated by the master cylinder 17 and output the braking fluid pressure to the control unit 16. A stroke sensor (not illustrated) detects a stroke amount that can be detected as an operation amount of a brake operation member (e.g., a brake pedal etc.) (not illustrated) operated by a driver, and outputs the detected stroke amount to the control unit 16. Here, the master pressure sensors S1 and S2 and the stroke sensor are electrically connected to each of the first ECU 16B and the second ECU 16C configuring the control unit 16. The first ECU 16B and the second ECU 16C acquire detection values from the master pressure sensors S1 and S2 and the stroke sensor. One master pressure sensor and one stroke sensor may be provided, and one master pressure sensor and one stroke sensor may be electrically connected to the first ECU 16B and the second ECU 16C. In this case, the master pressure sensor and the stroke sensor electrically connected to the first ECU 16B and the second ECU 16C correspond to the “third element”.

The first pressure sensor S3 detects a braking fluid pressure generated by the first electrically powered cylinder device 12A connected to the first wheel of the vehicle and outputs the braking fluid pressure to the control unit 16. The second pressure sensor S4 detects a braking fluid pressure generated by the second electrically powered cylinder device 12B connected to the second wheel of the vehicle and outputs the braking fluid pressure to the control unit 16.

As illustrated in FIG. 2, the linear motion conversion mechanism 14 is coupled to the piston 122 of the electrically powered cylinder device 12, and is driven by a rotational driving force (rotational motion) from the electric motor 11 to slide the piston 122 with respect to the cylinder 121. The linear motion conversion mechanism 14 of the present embodiment includes a ball screw 141 coupled to the piston 122 of the electrically powered cylinder device 12 as a linear moving portion, and a ball screw nut 142 screwed to the ball screw 141.

The ball screw 141 rotates with respect to the ball screw nut 142 by a rotational motion (rotational driving force) supplied from the electric motor 11, and relatively moves in the axial direction with respect to the ball screw nut 142. The ball screw nut 142 is supported so as to be relatively non-rotatable with respect to the hydraulic block 13. Thus, the ball screw 141 and the ball screw nut 142 convert the rotational motion of the electric motor 11, more specifically, the rotating shaft 111, into the linear motion of the ball screw 141. Therefore, the ball screw 141 serving as the linear moving portion performs linear motion together with the piston 122 of the electrically powered cylinder device 12.

As illustrated in FIG. 2, the power transmission unit 15 includes a driving gear 151 that rotates together with the rotating shaft 111 of the electric motor 11, more specifically, the rotating shaft 111 inserted through the rotating shaft accommodating portion 13A of the hydraulic block 13. In addition, the power transmission unit 15 includes a first driven gear 152 that engages with the driving gear 151, and a second driven gear 153 that is disposed coaxially with the first driven gear 152 through a shaft and transmits rotational motion (rotational driving force) to the ball screw 141 of the linear motion conversion mechanism 14. Thus, the power transmission unit can transmit the rotation to the ball screw 141 of the linear motion conversion mechanism 14 while reducing the rotational speed of the rotating shaft 111 of the electric motor 11.

In the present embodiment, the first driven gear 152 is provided, and the power transmission unit 15 includes three gears. However, for example, the first driven gear 152 may be omitted, and the driving gear 151 and the second driven gear 153 may be directly engaged with each other.

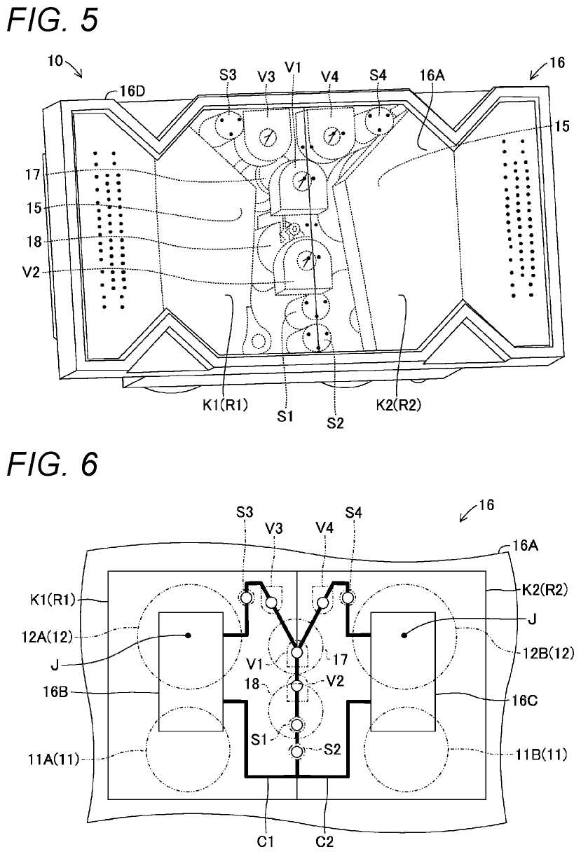

As illustrated in FIGS. 5 and 6, the control unit 16 of the present embodiment includes one circuit board 16A and as illustrated in FIG. 6, includes a first ECU 16B and a second ECU 16C assembled to the circuit board 16A. The circuit board 16A is accommodated and attached in a case 16D fixed at a corresponding position of the hydraulic block 13 so as to be perpendicular to the axis J of the electrically powered cylinder device 12. Note that the circuit board 16A, that is, the control unit 16 and the electric motor 11 of the present embodiment are disposed on opposite sides to each other with the hydraulic block 13 in between in the direction of the axis J of the electrically powered cylinder device 12. Here, in the case 16D, a connector for enabling communication with the outside is provided in correspondence with each of the first ECU 16B and the second ECU 16C (see FIG. 1).

Each of the first ECU 16B and the second ECU 16C is a microcomputer including a CPU, a ROM, a RAM, and various interfaces as main configuring components. Then, as illustrated in FIG. 6, the first ECU 16B is disposed together with the first circuit C1 serving as an electric circuit for electrically connecting to the first electromagnetic valve V3 serving as a first element and the master cut valve V1 and the simulator cut valve V2 serving as third elements in the first sector K1 set on the circuit board 16A. Similarly, the second ECU 16C is disposed together with the second circuit C2 serving as an electric circuit for electrically connecting to the second electromagnetic valve V4 serving as a second element and the master cut valve V1 and the simulator cut valve V2 serving as third elements in the second sector K2 set on the circuit board 16A.

Note that the first circuit C1 includes a contact (indicated by a solid circle in FIG. 6) and a wiring pattern (substrate pattern) that electrically connects the first ECU 16B, the first electric motor 11A, the first electromagnetic valve V3, the first pressure sensor S3, the master cut valve V1, the simulator cut valve V2, the master pressure sensors S1, S2 and the stroke sensor. The second circuit C2 includes a contact (indicated by a solid circle in FIG. 6) and a wiring pattern (substrate pattern) that electrically connects the second ECU 16C, the second electric motor 11B, the second electromagnetic valve V4, the second pressure sensor S4, the master cut valve V1, the simulator cut valve V2, and the master pressure sensors S1 and S2.

Here, the first sector K1 set on the circuit board 16A is included in the first region R1 set to be parallel to the axis J (i.e., the normal direction of the first sector K1) of the electrically powered cylinder device 12. The second sector K2 set on the circuit board 16A is included in the second region R2 set to be parallel to the axis J (i.e., the normal direction of the second sector K2) of the electrically powered cylinder device 12. That is, the first electrically powered cylinder device 12A which is the first element is disposed so as to face the first sector K1 in which the first circuit C1 is formed (on the normal line of the first sector K1). Furthermore, the second electrically powered cylinder device 12B which is the second element is disposed so as to face the second sector K2 in which the second circuit C2 is formed (on the normal line of the second sector K2).

The first ECU 16B and the first circuit C1 disposed in the first sector K1, that is, the first region R1 control the operations of the first electric motor 11A (i.e., the first electrically powered cylinder device 12A) and the first electromagnetic valve V3 disposed in the first region R1, and acquire the detection value of the braking fluid pressure detected by the first pressure sensor S3 disposed in the first region R1. On the other hand, the second ECU 16C and the second circuit C2 disposed in the second sector K2, that is, the second region R2 control the operations of the second electric motor 11B (i.e., the second electrically powered cylinder device 12B) and the second electromagnetic valve V4 disposed in the second region R2, and acquire the detection value of the braking fluid pressure detected by the second pressure sensor S4 disposed in the second region R2.

Furthermore, the master cut valve V1 and the simulator cut valve V2 (includes a master pressure sensor and a stroke sensor, as necessary) disposed at the boundary between the first sector K1 (first region R1) and the second sector K2 (second region R2) or in the region between the first sector K1 (first region R1) and the second sector K2 (second region R2), that is, the central portion of the hydraulic block 13 are electrically connected to both the first circuit C1 and the second circuit C2, and the operations thereof can be controlled by both the first ECU 16B and the second ECU 16C. In the present embodiment, the master cut valve V1 and the simulator cut valve V2 are arranged at the boundary between the first sector K1 (first region R1) and the second sector K2 (second region R2).

As a result, for example, when an abnormality occurs in the first ECU 16B that controls the operations of the master cut valve V1 and the simulator cut valve V2 at the normal time, the second ECU 16C can control the operations of the master cut valve V1 and the simulator cut valve V2 in place of the first ECU 16B. That is, in the vehicle brake device 10 of the present embodiment, the master cut valve V1 and the simulator cut valve V2 are not provided in correspondence with the first ECU 16B and the second ECU 16C, respectively, and the first ECU 16B and the second ECU 16C can control the operations of the common master cut valve V1 and the simulator cut valve V2.

Thus, in the vehicle brake device 10 of the present embodiment, the number of the electromagnetic valves and the like, specifically, the master cut valve V1 and the simulator cut valve V2 can be reduced while having redundancy. As a result, reduction in size of the vehicle brake device 10 can be achieved, and the manufacturing cost and the like of the vehicle brake device 10 can be reduced.

As illustrated in FIGS. 3, 5, and 6, the master cylinder 17 serving as a cylinder device is accommodated in a master cylinder accommodating portion 13C formed in a central portion (a boundary between the first sector K1 (first region R1) and the second sector K2 (second region R2)) of the hydraulic block 13. The master cylinder 17 of the present embodiment is disposed so as to be parallel to the rotating shaft 111 of the electric motor 11 and the axis J of the electrically powered cylinder device 12. The master cylinder 17 is connected to a reservoir (not illustrated) that stores brake fluid through a liquid path T3 formed in the hydraulic block 13. A master piston (not illustrated) of the master cylinder 17 is coupled to a brake operation member (e.g., a brake pedal etc.). Thus, in the master cylinder 17, the master piston slides and moves according to the operation of the brake pedal or the like by the driver, and as a result, a braking fluid pressure (master pressure) corresponding to the position of the master piston is generated in a fluid pressure chamber defined by the master piston inside the master cylinder 17. The master cylinder 17 supplies the generated braking fluid pressure (master pressure) to the wheel cylinders provided in the first wheel (e.g., the left front wheel of the vehicle) and the second wheel (e.g., the right front right wheel of the vehicle) through a liquid path not illustrated.

As illustrated in FIGS. 3, 5, and 6, the stroke simulator 18 is accommodated in a stroke simulator accommodating portion 13D formed at a central portion of the hydraulic block 13. The stroke simulator 18 of the present embodiment is disposed so as to be parallel to the rotating shaft 111 of the electric motor 11 and the axis J of the electrically powered cylinder device 12. When the master cut valve V1 is in the cutoff state and the simulator cut valve V2 is in the communicating state, the stroke simulator 18 generates a reaction force (load) with respect to the operation of the brake pedal or the like by the driver.

In the vehicle brake device 10 of the present embodiment, the circuit board 16A of the control unit 16, that is, the first ECU 16B and the second ECU 16C are arranged so as to be perpendicular to the axis J of the electrically powered cylinder device 12 (the rotating shaft 111 of the electric motor 11). In this case, as illustrated in FIG. 6, assume a case in which the electric motor 11 (the first electric motor 11A and the second electric motor 11B) and the electrically powered cylinder device 12 (the first electrically powered cylinder device 12A and the second electrically powered cylinder device 12B) are projected toward the circuit board 16A in the direction of the axis J of the electrically powered cylinder device 12 (the direction of the rotating shaft 111 of the electric motor 11). In this case, the sizes of the projection areas of the electric motor 11 (the first electric motor 11A, the second electric motor 11B) and the electrically powered cylinder device 12 (the first electrically powered cylinder device 12A, the second electrically powered cylinder device 12B) in the first sector K1 and the second sector K2 are not along the direction of the axis J of the electrically powered cylinder device 12 (the direction of the rotating shaft 111 of the electric motor 11) and are smaller than, for example, the projection area projected in the direction perpendicular to the axis J.

In particular, when the circuit board 16A (the control unit 16) is disposed so as to be perpendicular to the axis J of the electrically powered cylinder device 12 (the rotating shaft 111 of the electric motor 11), the projection area when the electric motor 11 and the electrically powered cylinder device 12 are projected is minimized in the first sector K1 and the second sector K2. When arranged (assembled) in the hydraulic block 13, the first electromagnetic valve V3 and the second electromagnetic valve V4 are generally arranged such that the projection with respect to the circuit board 16A does not overlap the projection of the electric motor 11 and the electrically powered cylinder device 12 with respect to the circuit board 16A. Therefore, when the projection areas of the electric motor 11 and the electrically powered cylinder device 12 in the first sector K1 and the second sector K2 are the minimum, it can be said that the arrangement range in which the first electromagnetic valve V3 and the second electromagnetic valve V4 can be arranged in the hydraulic block 13 is the maximum.

As a result, the degree of freedom in arranging (assembling) the first electromagnetic valve V3 and the second electromagnetic valve V4 in the hydraulic block 13 is improved.

Regarding the connection between the master cut valve V1, the simulator cut valve V2, the first electromagnetic valve V3, and the second electromagnetic valve V4 and the circuit board 16A, a hole needs to be formed as a contact in the circuit board 16A, and there exists an implementation restriction that arrangement of elements and wiring (copper foil pattern) of an electric circuit needs to be avoided around the provided hole (contact). If the master cut valve V1, the simulator cut valve V2, the first electromagnetic valve V3, and the second electromagnetic valve V4 are arranged at the central portion of the circuit board 16A, a hole (contact) is provided at the central part of the circuit board 16A. In this case, arrangement and wiring of elements in an electric circuit other than the drive circuit of the master cut valve V1, the simulator cut valve V2, the first electromagnetic valve V3, and the second electromagnetic valve V4 become complicated, and as a result, the circuit board 16A may be increased in size.

On the other hand, in the present example, the master cut valve V1 and the simulator cut valve V2 can be arranged at the boundary between the first sector K1 (first region R1) and the second sector K2 (second region R2). Furthermore, the first electromagnetic valve V3 can be arranged at the peripheral edge portion of the first sector K1, and the second electromagnetic valve V4 can be arranged at the peripheral edge portion of the second sector K2. That is, in the present example, as described above, the degree of freedom in the arrangement of the master cut valve V1, the simulator cut valve V2, the first electromagnetic valve V3, and the second electromagnetic valve V4 is high in the hydraulic block 13, and thus the arrangement described above can be realized.

In addition, for example, in a case where the circuit board 16A (the control unit 16) is arranged in parallel with the axis J of the electrically powered cylinder device 12 (the rotating shaft 111 of the electric motor 11), the projection area of the electrically powered cylinder device 12 to the circuit board 16A is larger than that in a case where the circuit board is arranged perpendicularly. In this case, when the first electromagnetic valve V3 and the second electromagnetic valve V4 are arranged so as to avoid projection of the electrically powered cylinder device 12 onto the circuit board 16A, the degree of freedom in the arrangement of the first electromagnetic valve V3 and the second electromagnetic valve V4 decreases. Alternatively, when the first electromagnetic valve V3 and the second electromagnetic valve V4 are arranged on the projection of the electrically powered cylinder device 12 onto the circuit board 16A, it is necessary to increase the thickness of the hydraulic block 13 between the circuit board 16A and the electrically powered cylinder device 12 to arrange the first electromagnetic valve V3 and the second electromagnetic valve V4. In these cases, the hydraulic block 13 increases in size.

On the other hand, in the vehicle brake device 10, the degree of freedom in the arrangement of the first electromagnetic valve V3 and the second electromagnetic valve V4 with respect to the hydraulic block 13 can be improved, as described above. As a result, in the vehicle brake device 10, the circuit board 16A can be arranged perpendicular to the axis J of the electrically powered cylinder device 12 (the rotating shaft 111 of the electric motor 11), and the first electromagnetic valve V3 and the second electromagnetic valve V4 can be arranged so as to be parallel to the rotating shaft 111 of the electric motor 11 and the axis J of the electrically powered cylinder device 12. Thus, a space for arranging the first electromagnetic valve V3 and the second electromagnetic valve V4 does not need to be separately secured, that is, the hydraulic block 13 does not need to be enlarged, reduction in size of the hydraulic block 13 can be achieved and reduction in size of the circuit board 16A (the control unit 16) also can be achieved. That is, reduction in size of the vehicle brake device 10 can be achieved.

In addition, since the first electromagnetic valve V3 and the second electromagnetic valve V4 are opening/closing means of the liquid path provided inside the hydraulic block 13, the arrangement of the first electromagnetic valve V3 and the second electromagnetic valve V4 in the hydraulic block 13 and the structure of the liquid path affect each other. Since the degree of freedom in arranging the first electromagnetic valve V3 and the second electromagnetic valve V4 in the hydraulic block 13 is improved, the configuration of the liquid path of the hydraulic block 13 can be simplified, and thus the hydraulic block 13 can be reduced in size.

The distance to the circuit board 16A (the control unit 16) facing each other on the axes of the first electromagnetic valve V3 and the second electromagnetic valve V4 can be shortened by arranging the first electromagnetic valve V3 and the second electromagnetic valve V4 so as to be parallel to the axis J of the electrically powered cylinder device 12 (the rotating shaft 111 of the electric motor 11). Thus, reduction in size of the vehicle brake device 10 can also be achieved.

In addition, in the vehicle brake device 10 of the present embodiment, the degree of freedom in arranging the first electromagnetic valve V3 and the second electromagnetic valve V4, and the first pressure sensor S3 and the second pressure sensor S4 can be improved, as described above. As a result, in the circuit board 16A, the first circuit C1 formed in the first sector K1 and the second circuit C2 formed in the second sector K2 can be made symmetrical with respect to, for example, the boundary between the first sector K1 (first region R1) and the second sector K2 (second region R2) as illustrated in FIG. 6.

Thus, in the development of the vehicle brake device 10, for example, after the first circuit C1 on the first sector K1 (first region R1) side is designed, the second circuit C2 formed in the second sector K2 (second region R2) can be easily designed by being formed to be a symmetrical shape of the first circuit C1. In addition, since the first circuit C1 and the second circuit C2 are symmetric with each other in manufacturing the circuit board 16A, the circuit board can be easily manufactured. Therefore, the development cost and the manufacturing cost required for the development of the first circuit C1 and the second circuit C2 in the circuit board 16A can be reduced.

Furthermore, in the vehicle brake device 10 of the present embodiment, the master cylinder 17 and the stroke simulator 18, which are heavy objects, can be disposed at the central portion of the hydraulic block 13, that is, at the boundary between the first sector K1 (first region R1) and the second sector K2 (second region R2). Thus, the weight balance in the vehicle brake device 10 can be optimized.

As can be understood from the above description, the vehicle brake device 10 of the present embodiment includes the electric motor 11 (the first electric motor 11A and the second electric motor 11B), the plurality of electrically powered cylinder devices 12 (the first electrically powered cylinder device 12A and the second electrically powered cylinder device 12B) that are driven by the electric motor 11 (each of the first electric motor 11A and the second electric motor 11B) and causes the fluid pressure chamber 123 defined by the cylinder 121 and the piston 122 to generate the fluid pressure corresponding to the position of the piston 122 sliding in the cylinder 121, and a circuit board 16A on which the electric circuit (the first circuit C1 and the second circuit C2) that controls the electric motor 11 (each of the first electric motor 11A and the second electric motor 11B) is formed, where the plurality of electrically powered cylinder devices 12 (the first electrically powered cylinder device 12A and the second electrically powered cylinder device 12B) are arranged side by side in a radial direction with axes J thereof being parallel to each other, and the circuit board 16A is disposed perpendicular to the axis J of the electrically powered cylinder device 12 (the first electrically powered cylinder device 12A and the second electrically powered cylinder device 12B).

According to this, the circuit board 16A is disposed perpendicular to the axis J of the electrically powered cylinder device 12 (the first electrically powered cylinder device 12A and the second electrically powered cylinder device 12B). Thus, the projection area when the electrically powered cylinder device 12 (the first electrically powered cylinder device 12A and the second electrically powered cylinder device 12B) is projected onto the circuit board 16A in the direction of the axis J of the electrically powered cylinder device 12 (the first electrically powered cylinder device 12A and the second electrically powered cylinder device 12B) is smaller than the projection area when projected in the direction perpendicular to the axis J of the electrically powered cylinder device 12 (the first electrically powered cylinder device 12A and the second electrically powered cylinder device 12B). As a result, a degree of freedom in the arrangement of components provided in the vehicle brake device 10, specifically, the master cut valve V1 and the simulator cut valve V2, the first electromagnetic valve V3 and the second electromagnetic valve V4, the master pressure sensors S1 and S2, the stroke sensor, the first pressure sensor S3, the second pressure sensor S4, and the like is improved. As a result, the vehicle brake device 10 can be reduced in size. Note that “perpendicular” includes substantially perpendicular, that is, that which is intended to be perpendicular but also includes that which is slightly deviated from perpendicular due to tolerance, arrangement error, or the like.

In this case, the rotating shaft 111 of the electric motor 11 (the first electric motor 11A and the second electric motor 11B) is parallel to the axis J of the electrically powered cylinder device 12 (the first electrically powered cylinder device 12A and the second electrically powered cylinder device 12B) and is arranged side by side in the radial direction.

According to this, the rotating shaft 111 of the electric motor 11 (the first electric motor 11A and the second electric motor 11B) can be arranged side by side in the radial direction with the axis J of the electrically powered cylinder device 12 (the first electrically powered cylinder device 12A and the second electrically powered cylinder device 12B) parallel to each other. Therefore, for example, the electric motor 11 (the first electric motor 11A and the second electric motor 11B) and the electrically powered cylinder device 12 (the first electrically powered cylinder device 12A and the second electrically powered cylinder device 12B) can be disposed so as not to generate an empty space in the hydraulic block 13 and the circuit board 16A, as compared with a case where the rotating shaft 111 and the axis J are disposed so as not to be parallel to each other. As a result, the vehicle brake device 10 can be reduced in size.

### 2. Modified Example

The vehicle brake device 10 of the embodiment described above is assembled to the hydraulic block 13 such that the electric motor 11 is below the electrically powered cylinder device 12 in the vertical direction in the posture of being assembled to the vehicle. However, the arrangement of the electric motor 11 and the electrically powered cylinder device 12 assembled to the hydraulic block 13 is not limited. For example, in a posture in which the vehicle brake device 10 is assembled to the vehicle, the electrically powered cylinder device 12 can be assembled to the hydraulic block 13 so as to be below the electric motor 11 in the vertical direction.

In addition, in the vehicle brake device 10 according to the embodiment described above, the power transmission unit 15 is arranged between the hydraulic block 13 and the control unit 16. However, the arrangement of the power transmission unit 15 is not limited. For example, it is also possible to configure such that the power transmission unit 15 is assembled to the hydraulic block 13 on the side opposite to the control unit 16, and the rotational motion (rotational driving force) of the rotating shaft 111 of the electric motor 11 is transmitted to the linear motion conversion mechanism 14. Note that in this case, it goes without saying that the arrangement direction of the electric motor 11 and the arrangement direction of the electrically powered cylinder device 12 are changed in accordance with the arrangement of the power transmission unit 15.

In the embodiment described above, the ball screw 141 is used as the linear moving portion of the linear motion conversion mechanism 14, and the ball screw nut 142 screwed to the ball screw 141 is used so as to transmit the rotational motion to the ball screw 141. However, as the linear motion conversion mechanism, any configuration such as a combination of a roller screw and a roller screw nut, a combination of a trapezoidal screw or a sliding screw and a nut, or the like may be adopted as long as the rotational motion can be converted into the linear motion.

Furthermore, in the embodiment described above, in the circuit board 16A of the control unit 16, the first sector K1 and the second sector K2 are set, the first circuit C1 that controls the first electromagnetic valve V3 and the first pressure sensor S3 serving as the first elements is arranged so as to face the first sector K1, and the second circuit C2 that controls the second electromagnetic valve V4 and the second pressure sensor S4 serving as the second elements is arranged so as to face the second sector K2. In the embodiment described above, the first electromagnetic valve V3 and the first pressure sensor S3 controlled only by the first circuit C1 are disposed in the first region R1 including the first sector K1, and the second electromagnetic valve V4 and the second pressure sensor S4 controlled only by the second circuit C2 are disposed in the second region R2 including the second sector K2. However, it is of course possible to set the first region R1 and the second region R2 without setting the first sector K1 and the second sector K2 in the circuit board 16A.

In the embodiment described above, the first sector K1 (first region R1) and the second sector K2 (second region R2) are set for one circuit board 16A of the control unit 16. However, the circuit board 16A may be configured by a plurality of substrates, and the first sector K1 (first region R1) and the second sector K2 (second region R2) may be set.

Furthermore, in the embodiment described above, the circuit board 16A has a range wider than the total range of the first sector K1 and the second sector K2. However, the total range of the first sector K1 and the second sector K2 may coincide with the range of the circuit board 16A.

1. A vehicle brake device comprising:
an electric motor;
a plurality of electrically powered cylinder devices that are driven by the electric motor and that causes a fluid pressure chamber defined by a cylinder and a piston to generate a fluid pressure corresponding to a position of the piston sliding in the cylinder; and
a circuit board on which an electric circuit that controls the electric motor is formed; wherein
the plurality of electrically powered cylinder devices are arranged side by side in a radial direction with axes thereof being parallel to each other; and
the circuit board is disposed perpendicular to the axis of the electrically powered cylinder device.

2. The vehicle brake device according to claim 1, wherein a rotating shaft of the electric motor is parallel to the axis of the electrically powered cylinder device and is arranged side by side in a radial direction.
